(19) United States
(12) Patent Application Publication
(10) Pub. No.: US 2009/0189749 A1
(43) Pub. Date: Jul. 30, 2009

(54) Haptic Interface Device and Method for Using Such

(76) Inventor: Mark A. Salada, Denver, CO (US)

Correspondence Address: HAMILTON, DESCANCTIS & CHA (GENERAL), 8601 W. CROSS DRIVE, F5-301, LITTLETON, CO, 80123, US

(21) Appl. No.: 12/302,902

(22) PCT Filed: Nov. 6, 2007
(86) PCT No.: PCT/US07/83692

§ 371 Date: Dec. 1, 2008

Related U.S. Application Data
(60) Provisional application No. 60/866,374, filed on Nov. 17, 2006.

(51) Int. Cl. G08B 6/00; G06F 3/033

(52) U.S. Cl. 340/407.2; 345/157

(57) ABSTRACT

Various embodiments of the present invention provide systems and methods for interacting with a computer. For example, a haptic interface device is disclosed that includes a thin, flexible passive actuating element and a sensor. The thin, flexible passive actuating element includes at least one unattached edge that is susceptible to manipulation, and the sensor is operable to detect a manipulation of the thin, flexible passive actuating element and to provide an output corresponding to the detected manipulation. In some cases of the aforementioned embodiments, the thin, flexible passive actuating element provides a haptic feedback to a user providing the manipulation, and the haptic feedback simulates the haptic sensation of paper such as, for example a sheet of paper, a playing card, an index folder or the like.

### CROSS REFERENCE TO RELATED APPLICATIONS

The present application claims the benefit of (i.e., is a non-provisional claiming priority to) U.S. Provisional Patent Application No. 60/866,374 entitled “Haptic Page-Flicker Device”, and filed by Salada on Nov. 17, 2006. The entirety of the aforementioned patent application is incorporated herein by reference for all purposes.

### BACKGROUND OF THE INVENTION

The present invention is related to haptic devices, and more particularly to systems and methods for interacting with a computer using a haptic device.

Haptic interfaces are devices that allow humans to interact with virtual (i.e., computer-generated) environments through the sense of touch. Haptic interfaces have developed rapidly over the past fifteen years, and are found in industries as diverse as robot-assisted surgery, surgical training, video game interface, computer mice, automotive informatics, and rapid prototyping, among others. Most of today's haptic interfaces, however, require that users grasp an implement such as a stylus or mouse through which they experience the virtual environment. It is not possible for a user to put his or her fingertips directly on a virtual object. Thus, a wide variety of tasks such as palpating tissue in search of tumors, getting a feel for a piece of fabric, or testing the freshness of a piece of fruit, are not readily accomplished with existing technology.

Several academic and industrial groups are dedicated to adding haptic sensations to electronic media such as computers. Enhancing the multimedia effectiveness of digital media may utilize controlled knobs and sliders. The most active area of investigation is on adding a haptic dimension to scrolling and pointing tasks. A great deal of research focuses on the automotive industry, enhancing the “feel” of the extensive ensemble of control devices present on a dashboard. Anywhere humans use their hands and fingers to interact with the world is an opportunity to mimic, alter, and exploit the exchange of haptic information and enhance the experience.

The most popular method for browsing electronic media such as web pages or electronic books is for the user to press a button (either physically or through a mouse click). The association between pressing a button and turning a page is unnatural, a barrier that most people overcome relatively quickly. However, for certain populations like the very young and the very old, the unnatural association is yet another impediment to learning and using computer products. Even with the adjustment, many people claim to have difficulty reading extensively online, preferring instead to print a hard copy to read. Part of the satisfaction and part of the comfort of reading a hardcopy is the haptic sensation of holding and manipulating paper.

Hence, for at least the aforementioned reasons, there exists a need in the art for advanced systems and methods for interacting with electronic media or a virtual environment.

### BRIEF SUMMARY OF THE INVENTION

The present invention is related to haptic devices, and more particularly to systems and methods for interacting with a computer using a haptic device.

Various embodiments of the present invention provide haptic interface devices that include a thin, flexible passive actuating element and a sensor. The thin, flexible passive actuating element includes at least one unattached edge or corner that is susceptible to manipulation, and the sensor is operable to detect a manipulation of the thin, flexible passive actuating element and to provide an output corresponding to the detected manipulation. As used herein, the term “passive” is used in its broadest sense to mean any element that is not moved by a motor. It should be noted that while some embodiments of the present invention utilize passive elements, that other embodiments may use active elements. In some cases of the aforementioned embodiments, the thin, flexible passive actuating element provides a haptic feedback to a user providing the manipulation, and the haptic feedback simulates the haptic sensation of paper such as, for example a sheet of paper, a playing card, an index folder or the like. The manipulation may be, but is not limited to, a movement of the thin, flexible passive actuating element; a force applied to the thin, flexible passive actuating element; a vibration of the thin, flexible passive actuating element; and/or a sound emitted due to movement of thin, flexible passive actuating element. The sensor may be, but is not limited to, a hall effect sensor, an optical sensor, an inductive sensor, a capacitive sensor, a thermal sensor, a stress or strain sensor, a force sensor, and/or a piezoelectric sensor. In one particular instance of the aforementioned embodiments, the device further includes a base. In such instances, the sensor is incorporated into the base, and the thin, flexible passive actuating element is attachable to the base and detachable from the base.

In various instances of the aforementioned embodiments, the sensor is coupled to the thin, flexible passive actuating element by a coupling mechanism that may be, but is not limited to, a mechanical coupling, an electronic coupling, an acoustic coupling, and/or an optical coupling. In one particular embodiment of the present invention, the coupling mechanism is the electrical coupling, and the thin, flexible passive actuating element is a plastic sheet including a material capable of interfering with an electrical field. In such embodiments, the sensor may be an inductive sensor capable of producing an electrical field and of detecting an interference with the electrical field. The material capable of interfering with an electrical field may be, but is not limited to, a metal disposed on a surface of the plastic sheet, or a metal embedded in the plastic sheet. In another particular embodiment of the present invention, the coupling is the mechanical coupling, and the sensor may be, but is not limited to, a force sensor, and/or a strain sensor.

In other instances of the aforementioned embodiments, the output is an electrical signal that corresponds to an electronic media navigation function. In such instances, the electronic media navigation function may be, but is not limited to, a next page navigation, a previous page navigation, a bookmark navigation, a move to a bookmark navigation, a scroll navigation, or a highlighting navigation.

In yet other instances of the aforementioned embodiments, the haptic interface device is associated with a processor and a computer readable medium. In such instances, the output is provided to the processor, and the computer readable medium includes instructions executable by the processor to: receive the output; and generate a navigation command based at least in part on the output. The navigation command may be, but is not limited to, a next page navigation, a previous page navigation, a bookmark navigation, a move to a bookmark navigation, a scroll navigation, or a highlighting navigation. In various of the aforementioned instances, the thin, flexible passive actuating element includes at least a first region and a second region. In such instances, the computer readable medium may further include instructions executable to: identify manipulation of the first section; identify manipulation of the second section; generate a first navigation command based at least in part on an identified manipulation of the first section; and generate a second navigation command based at least in part on an identified manipulation of the second section. The first navigation command may be distinct from the second navigation command. It should be noted that three or more regions are possible with each region possibly indicating a different command.

Yet other embodiments of the present invention provide methods for navigating an electronic media displayed by an electronic device. The methods involve providing a haptic device that includes an actuating element, a sensor and a base. The actuating element is a sheet of material that includes at least one unattached edge that is susceptible to manipulation, the sensor is incorporated in the base, and the actuating element is attached to the base. The methods further include detecting, by the sensor, a manipulation of the actuating element; producing an electrical signal in response to the detected manipulation of the actuating element; and navigating the electronic media based at least in part on the produced electrical signal. In particular instances of the aforementioned embodiments, the actuating element includes at least a first region and a second region. In such instance, one electrical signal may be generated whenever a manipulation of the first region is detected and another electrical signal may be generated whenever a manipulation of the second region is detected.

Yet further embodiments of the present invention provide electronic devices that include a haptic device, a processor and a computer readable medium. The haptic device includes an actuating element, a sensor and a base. The actuating element is a sheet of material that includes at least one unattached edge that is susceptible to manipulation, and is attached to the base. The sensor is operable to detect a manipulation of the actuating element and to provide an output indicating the detected manipulation, and is incorporated in the base. The computer readable medium includes instructions executable by the processor to: receive the output; and generate a navigation command based at least in part on the output. In some instances of the aforementioned embodiments, the electronic device is a peripheral device such as, for example, wherein the electronic device is a peripheral device selected from a group consisting of: a keyboard, a mouse, a display, a joystick, a touchpad, a gaming console, a television remote control, or an automobile steering wheel. In various instances of the aforementioned embodiments, the electronic device includes a display. In some embodiments of the present invention, the electronic device is may be, but is not limited to, a cellular or mobile telephone, an electronic reading device, a personal digital assistant, an audio player, a video player, a laptop computer, and/or a navigation device.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a block diagram of a haptic device in accordance with one or more embodiments of the present invention;

FIG. 2a depicts a computer incorporating a haptic device in accordance with various embodiments of the present invention;

FIG. 2b shows a cross-sectional view of the haptic device of FIG. 2a;

FIG. 3a depicts a computer peripheral incorporating a haptic device in accordance with various embodiments of the present invention;

FIG. 3b depicts a stand alone haptic device in accordance with one or more embodiments of the present invention that is attached to a laptop computer;

FIGS. 4a-4c depict various approaches for detecting movement and/or location of a thin, flexible actuator element using an inductive sensor in accordance with different embodiments of the present invention;

FIG. 5 depicts an optical sensor used to detect movement and/or location of a thin, flexible actuator element in accordance with some embodiments of the present invention;

FIG. 6 shows a pressure sensor used to detect movement and/or location of a thin, flexible actuator element in accordance with some embodiments of the present invention;

FIG. 7 is a block diagram of a circuit for detecting movement of a thin, flexible actuator element using one or more inductive sensors in accordance with various embodiments of the present invention.

### DETAILED DESCRIPTION OF THE INVENTION

The present invention is related to haptic devices, and more particularly to systems and methods for interacting with a computer using a haptic device.

Various embodiments of the present invention provide haptic interface devices that include a thin, flexible passive actuating element and a sensor. The thin, flexible passive actuating element includes at least one unattached edge that is susceptible to manipulation, and the sensor is operable to detect a manipulation of the thin, flexible passive actuating element and to provide an output corresponding to the detected manipulation. As used herein, the term “passive” is used in the sense that the element is not moved by an attached motor. In some cases of the aforementioned embodiments, the thin, flexible passive actuating element provides a haptic feedback to a user providing the manipulation, and the haptic feedback simulates the haptic sensation of paper. The manipulation may be, but is not limited to, a movement of the thin, flexible passive actuating element; a force applied to the thin, flexible passive actuating element; a vibration of the thin, flexible passive actuating element; and/or a sound emitted due to movement of thin, flexible passive actuating element. The sensor may be, but is not limited to, a hall effect sensor, an optical sensor, an inductive sensor, a capacitive sensor, a thermal sensor, a stress or strain sensor, a force sensor, and/or a piezoelectric sensor. In one particular instance of the aforementioned embodiments, the device further includes a base. In such instances, the sensor is incorporated into the base, and the thin, flexible passive actuating element is attachable to the base and detachable from the base.

In various instances of the aforementioned embodiments, the haptic interface device is associated with a processor and a computer readable medium. As used herein, the phrase “computer readable medium” is used in its broadest sense to mean any media that is accessible to a processor. Thus, for example, a computer readable medium may be a floppy disk, a hard-disk drive, a CD-ROM, a DVD-ROM, a flash memory card, a USB flash drive, an nonvolatile RAM (NVRAM or NOVRAM), a FLASH PROM, an EEPROM, an EPROM, a PROM, a RAM, a ROM, a magnetic tape, an optical disk, or any combination thereof. Based on the disclosure provided herein, one of ordinary skill in the art will recognize a variety of media that may be utilized in relation to different embodiments of the present invention. In such instances, the output is provided to the processor, and the computer readable medium includes instructions executable by the processor to: receive the output; and generate a navigation command based at least in part on the output. As used herein, the phrase “instruction” is used in its broadest sense to mean any operator that directs a proceeding operation. Thus, for example, an instruction executable by a processor may be in the form of source code, object code, interpretive code, executable code, hardwired instructions or combinations thereof. Based on the disclosure provided herein, one of ordinary skill in the art will recognize a variety of instruction types that may be utilized in relation to different embodiments of the present invention. The navigation command may be, but is not limited to, a next page navigation, a previous page navigation, a bookmark navigation, a move to a bookmark navigation, a scroll navigation, or a highlighting navigation.

Various embodiments of the present invention provide devices and methods for interacting with electronic media and/or a virtual environment through use of real world sensations. As just one of many advantages that may be achievable using one or more embodiments of the present invention, a user may be presented with a more comfortable intuitive interaction with electronic media or a virtual environment. Particular embodiments of the present invention mimic the known sensations of handling or manipulating paper. Some such embodiments include an actuating element meant to simulate paper (also referred to herein as an actuating member or actuator); a sensor that detects the movement, force, and/or frequency response of the actuating element; and the electronics to produce a control signal corresponding to the detected movement, force, and/or frequency response.

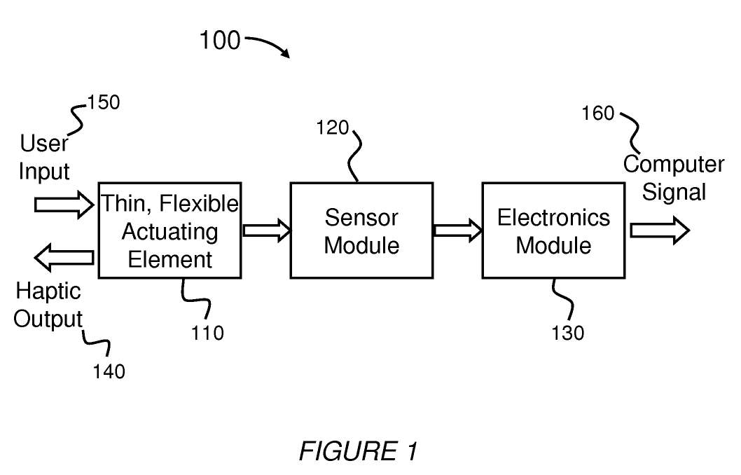

Turning to FIG. 1, a block diagram of a haptic device 100 is presented in accordance with one or more embodiments of the present invention. Haptic device 100 includes a paper-like actuating element 110, a sensor module 120 and an electronic module 130. Paper-like actuating element 110 may be any element that provides some level of touch sensitivity corresponding to the feel of a paper sheet. Thus, paper-like actuating element may be a thin, flexible passive actuating element. This feel or haptic sensation is fed back to a user as a haptic output 140. A variety of haptic sensations may be achieved through paper-like actuating element 110 by, for example, varying the properties of the actuating element, such as, but not limited to, stiffness, texture, and/or material. Further, paper-like actuating element 110 accepts manipulation from the user (i.e., user input 150), and provides one or more signals indicative of the manipulation to a sensor module 120. Alternatively or in addition, sensor module 120 senses or otherwise observes any manipulation of paper-like actuating element 110.

Sensor module 120 includes one or more sensors that are capable of receiving signals from paper-like actuating element 110 and converting those signals into one or more corresponding electronic signals. In one particular embodiment of the present invention, sensor module 120 includes a force sensor that senses a force applied to thin, flexible passive actuating element relative to a datum. Alternatively or in addition, sensor module 120 includes a motion sensor that senses a deflection of the thin, flexible passive actuating element from a center point. Alternatively or in addition, sensor module 120 includes a vibration sensor that senses an oscillation and/or movement frequency of the thin, flexible passive actuating element. Based on the disclosure provided herein, one of ordinary skill in the art will recognize a variety of sensors that may be used in relation to different embodiments of the present invention.

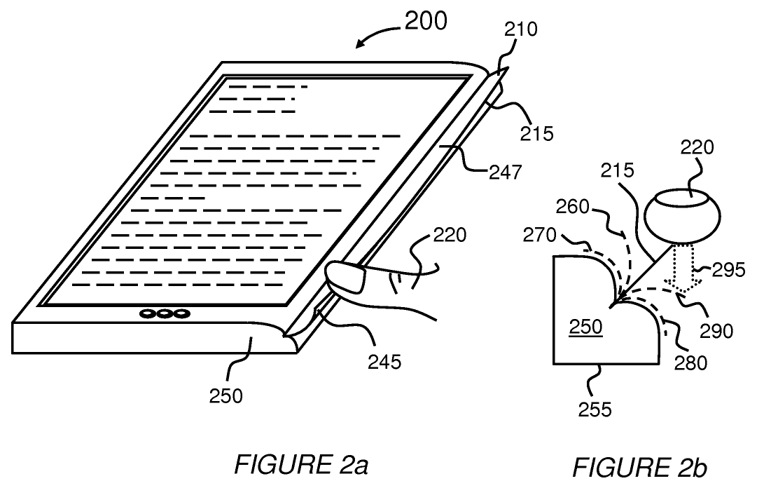

Turning to FIG. 2a, a computer 200 incorporating a haptic device 210 is depicted in accordance with various embodiments of the present invention. Computer 200 may be any microprocessor based device capable of receiving and responding to input information. Thus, computer 200 may be, but is not limited to, a personal digital assistant, a cellular telephone, an electronic book, a laptop computer, a personal computer, or the like. Based on the disclosure provided herein, one of ordinary skill in the art will recognize a variety of computers that may be used in relation to different embodiments of the present invention.

Haptic device 210 includes an actuating element 215 and sensors (not shown) that allow for detecting movement of actuating element 215. In this case, actuating element 215 is meant to simulate a piece of paper. In some embodiments of the present invention, actuating element 215 is a thin plastic sheet or paper sheet offering desired thin, flexible sensory characteristics. As some particular examples, actuating element 215 may be a thin film made of cellulose, acetal, polyester, fluoropolymer (like Teflon™), or polymide (like Kapton™), or any other suitable plastic, synthetic or natural rubber materials, regular printing paper, laminated paper, card stock paper, light absorbing paper, metal or any combination thereof. For example, actuating element 215 may be neodymium-iron-boron bonded with synthetic rubber, ferrite bonded with synthetic rubber, or simply metallic leaf bonded to paper or plastic with an adhesive. Actuating element 215 is connected to computer 200 either directly as shown, or may be connected to computer 200 via connection to a peripheral (not shown) that is connected to computer 200. Such peripherals may include, but are not limited to, a keyboard, a mouse, or a display. As shown, actuating element 215 is integrated with computer 200, however, in other embodiments of the present invention, actuating element 215 may be a stand alone peripheral that may be communicably coupled to computer 200 by, for example, a USB interface or a Bluetooth™ interface. Based on the disclosure provided herein, one of ordinary skill in the art will appreciate various other approaches for implementing actuating element 215 that allows for communication of information to/from computer 200.

In some embodiments of the present invention, an edge of actuating element 215 is attached along a region where sensor devices exist that are capable of detecting movement of actuating element 215. In one particular embodiment of the present invention, the mode of sensing manipulation of actuating element 215 includes using one or more inductive sensors embedded in an edge of computer 200 or otherwise incorporated into computer 200. In such cases, actuating element 215 includes a thin layer or region of ferric metal imbedded within the thin, flexible material or disposed on the surface of the thin, flexible material. Such a method of sensing enables position and speed detection of actuating element 215, while not necessarily detecting thumb 220. Other sensors may include, but are not limited to, one or more optical sensors designed and implemented to detect the position and movement of actuating element 215, force sensors at the base or center of actuating element 215 to detect and derive movement of the element; stress and/or strain sensors in the simulated paper itself that convey the shape, displacement, and movement of actuating element 215. As other examples, capacitive sensors, Hall-effect sensors, thermal sensors and/or piezoelectric sensors may be employed. Based on the disclosure provided herein, one of ordinary skill in the art will recognize other sensors and combinations of sensors that may be used in relation to different embodiments of the present invention.

In some embodiments of the present invention, the sensors may be designed to sense a continuous pressure applied to actuating element 215, vibration of actuating element 215, or a bend in actuating element 215. In one particular embodiment of the present invention, actuating element 215 and the associated sensors are designed to receive haptic input via a thumb 220 or other digit, and to react to that input in a way that allows for navigation through electronic media. For example, actuating element 215 may be used to replace “page up” and “page down” keys typically incorporated on a keyboard or other user interface of computer 210. By doing so, where a user presses or flicks up on actuating element 215 a page up signal or function may follow, and when the user presses or flicks down a page down signal or function follows. Of note, where computer 200 is used to read an electronic book, the aforementioned page up and page down functions operate to turn pages of the electronic book to the preceding and succeeding pages, respectively. In contrast to using a page up and page down button on a keyboard, actuating element 215 offers a “paper-like” feel providing a user reading an electronic book a more familiar sensation. The result is a more satisfying haptic sensation for a common activity that mimics the intimate and deep-seated association of reading an actual book, or magazine. Such haptic sensations may be defined by its texture, stiffness, damping and deformation qualities. Said another way, the aforementioned embodiment makes electronic reading more like offline reading. Further, haptic device 210 may be designed such that it requires very little power, making it viable for use in relation to portable electronic devices as well as non-portable electronic devices such as personal computers.

Turning to FIG. 2b, a cross-sectional view of a portion 250 of haptic device 210 is shown. As shown, thumb 220 moves from one location to another as indicated by an arrow 295. In moving, thumb 220 applies a force to actuating element 215 moving it through one deflection point (indicated by a dashed line 290) and on to another deflection point (indicated by a dashed line 280). A sensor embedded in a substrate 255 is capable of detecting a difference between the first deflection point indicated by dashed line 290 and the second indicated by dashed line 280. The sensor may provide an indication of the particular deflection to a processor that may execute a software algorithm that applies meaning to the different deflections. For example, a deflection to the point indicated by dashed line 290 may indicate a slow scrolling change of the page of a book. In contrast, a deflection to the point indicated by dashed line 280 may indicate an immediate change of page content from the current page to a subsequent or previous page. In some cases, thumb 220 may be immediately released when holding actuating element 215 at the deflection point 280 causing actuating element 215 to initially move from the deflection point indicated by dashed line 280 through the deflection point indicated by dashed line 290 and on through deflection points indicated by dashed lines 260, 270, and then back. This results in a vibration or oscillation being detected by the sensors. The sensor may indicate this vibration and in some cases an amplitude of the harmonics thereof to the processor that may execute a software algorithm that applies meaning to the sensed vibration. For example, the vibration may indicate a rapid flip through a number of pages. The direction of the page flip, whether it be forward or backward, may be indicated by the initial deflection point (e.g., the deflection point indicated by dashed line 280 contrasted with the deflection point indicated by dashed line 270). Further, the number of pages flipped through may be determined by the amplitude of the harmonics of the vibration or the level of the initial deflection (e.g., the deflection point indicated by dashed line 280 contrasted with the deflection point indicated by dashed line 290).

Based on the disclosure provided herein, one of ordinary skill in the art will recognize a variety of interpretations that may be applied to different manipulations sensed by the sensors attached to actuating element 215. For example, a page change may be effected by the release of the actuating element rather than the pressing thereof. This would be much like pulling a group of pages of a book in one direction and then releasing one of the pages to turn the page. This would mimic the “flicking” action that many users utilize when turning pages. The direction of the page change could be controlled, for example, by the direction of the initial deflection of the actuating device (e.g., pulling to the deflection point represented by dashed line 270 to go to the preceding page, or pulling to the deflection point represented by dashed line 280 to go to the succeeding page).

As another example, the sensors discussed in relation to FIG. 2a and FIG. 2b may be able to detect a localized deflection such as a deflection that is evident at a point 245, but that is not repeated at a point 247 along actuating element 215. This difference in detected manipulation position can be used, for example, to implement scrolling functionality with the direction of the scroll controlled by the direction that thumb 220 is moved along actuating device 215 (i.e., the direction that the user slides their thumb up or down actuating element 215). In addition to navigation signals, haptic device 210 may be used to perform other functions including, but not limited to, highlighting a line of text when depressing a section of actuating element 215 for a given duration, or storing a bookmark when the corner of actuating element 215 is temporarily folded. As another example, a sensed deflection at point 247 may hold different meaning than a sensed deflection at point 245. As a particular example, causing a flicking action at or near point 245 may move a user to the next chapter or other designated portion of an electronic book, and causing the same flicking action at or near point 247 may move the user to the next page of the electronic book.

In one particular embodiment of the present invention, haptic device 210 includes an actuating element that offers a thin, flexible feel to a digit manipulating the actuating element. Sensors are included that detect identifiable manipulations of the actuating element. In some cases, the manipulation may cause motion, force, vibration, or sound to be transmitted via haptic device 210, and these may be sensed by a sensor. Where the sensor is a sound sensor, it may be able to detect the frequency and/or amplitude of any vibration caused by manipulating the actuating element. Haptic device 210 executes an algorithm or process that determines what type of interaction is indicated by the sensed manipulation. For example, it may be determined whether the manipulation is sensed as motion, force, vibration, sound, and/or another user defined or custom sensory characteristic. The algorithm or process then proceeds to quantify the manipulation to indicate, for example, the amount and direction of a force, or the frequency of a vibration. This algorithm may be implemented, for example as instructions executable by a microprocessor included with computer 200 (e.g., software) and maintained on a computer readable medium included with computer 200. While a standard microprocessor executing software or firmware instructions may be used, it should be noted that in some cases, the “microprocessor” may be a hardwired device, such as, an FPGA or ASIC, and that the instructions executable by the microprocessor may be hard coded into the ASIC itself. The thin, flexible qualities of the actuating element provide a haptic feedback to the user enhancing the user's experience. In particular cases, the actuating element is designed to wear out, and may be replaced without requiring replacement of the entirety of haptic device 210. Further, the actuating element may be replaced by a different element type to enable a variety of haptic sensations. For example, a relatively flexible actuating device may be replaced by a stiffer, more plastic feeling actuating device allowing for haptic device 210 to offer a greater range of haptic experiences.

Embodiments of the present invention that utilize a thin, flexible actuating device are capable of providing a paper handling experience similar to that sensed when reading a book or magazine. In particular, such embodiments produce the sensation of flipping or thumbing (browsing) through pages in a book. As an add-on to existing electronic devices that replace paper or book equivalents, such as personal digital assistants (PDAs), e-book readers, and laptop computers, the aforementioned embodiment of the present invention enables humans to relate to electronic devices similar to how they already relate to books.

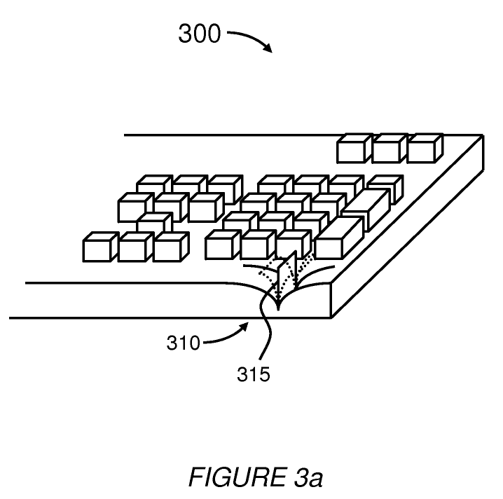

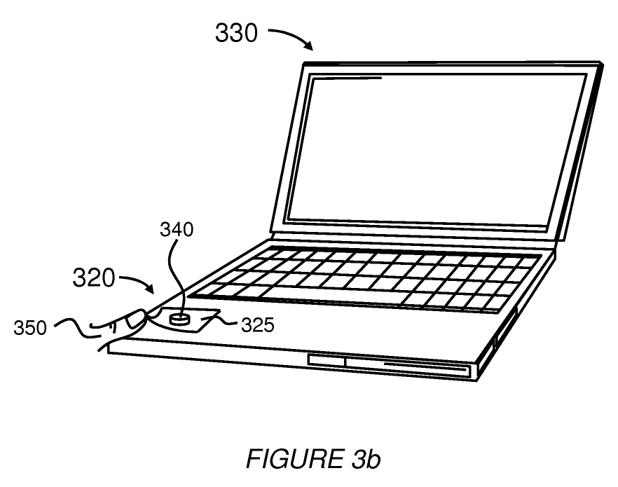

Turning to FIG. 3a, a keyboard 300 including a haptic device 310 is depicted in accordance with other embodiments of the present invention. Keyboard 300 may be capable of gathering signals generated by haptic device 310, and transferring the collected signals to a computer (not shown) that is associated with keyboard 300. In some cases, two haptic devices may be incorporated with keyboard 300 with one at either end. This would allow a user to utilize either a right hand or a left hand. Haptic device 310 includes an actuating element 315 and sensors (not shown) that allow for detecting movement of actuating element 315. In this case, actuating element 315 is meant to simulate a piece of paper, and operates similar to that discussed above in relation to FIG. 2.

Based on the disclosure provided herein, one of ordinary skill in the art will recognize other peripherals into which a haptic device in accordance with one or more embodiments of the present invention may be incorporated. For example, a haptic device in accordance with one or more embodiments of the present invention may be integrated with a steering wheel in an automobile to enhance navigation of a car stereo radio, a GPS device, or any other electronic device in the vehicle. As another example, a haptic device in accordance with different embodiments of the present invention may be integrated with dashboard systems in automobiles, cockpit systems in airplanes, or navigation systems on boats. Further, haptic devices in accordance with some embodiments of the present invention may be integrated with multiple different computer peripherals (e.g., a keyboard and a mouse) with each instance serving a particular navigation duty in relation to the associated computer. For example, one haptic device located on the edge of a computer monitor may be used to enable rapid navigation of the virtual desktop and/or hard-drive files, while that on an associated keyboard may be used to navigate any open folders or files on the computer. A haptic device in accordance with embodiments of the present invention may be incorporated into a cellular telephone to enable rapid navigation of a directory or address book.

Turning to FIG. 3b, a stand alone haptic device 320 is shown in relation to a laptop computer 330. As shown, haptic device 320 includes a thin, flexible actuator element 325 and an attached substrate 340. Substrate 340 includes one or more sensors capable of detecting manipulation of actuator element 325, a body for attaching to the surface of laptop computer 330, and a wireless transmitter for transmitting sensed manipulations of actuator element 325 to laptop computer 330.

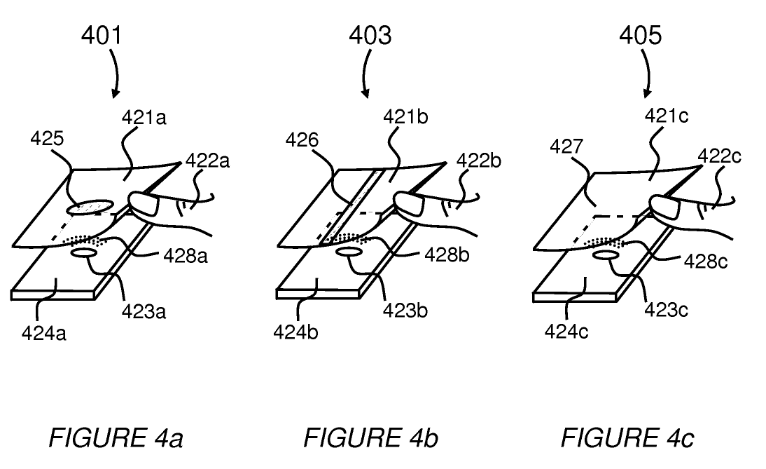

Turning to FIG. 4, three different approaches for detecting movement and/or location of a thin, flexible actuator element using an inductive sensor are depicted. Referring to FIG. 4a, a coil 423a associated with an inductive sensor is imbedded in a device substrate 424a. Device substrate 424a may be part of, for example, keyboard, a personal digital assistant, a cell phone, or other device as are known in the art. A thin, flexible actuator element 421a is anchored or otherwise disposed in relation to coil 423a. Thin, flexible actuator element 421a includes a metal layer 425 disposed on the surface thereof in the shape of a circle. When a user's digit 422a applies force to thin, flexible actuator element 421a, metal layer 425 is moved in relation to coil 423a resulting in the disruption of an electrical field 428a (shown as dotted lines) generated by another device (not shown) imbedded in substrate 424a. In similar fashion to the operation of a metal detector, coil 423a receives an electric current reflecting the disruption caused by moving metal layer 425 in relation to electrical field 428a. This electric current represents a location of metal layer 425 relative to coil 423a.

Referring to FIG. 4b, a coil 423b associated with an inductive sensor is imbedded in a device substrate 424b. Again, device substrate 424b may be part of, for example, keyboard, a personal digital assistant, a cell phone, or other device as are known in the art. A thin, flexible actuator element 421b is anchored or otherwise disposed in relation to coil 423b. Thin, flexible actuator element 421b includes a metal layer 426 in the shape of a bar extending along at least a portion of the surface of thin, flexible actuator element 421b. When a user's digit 422b applies force to thin, flexible actuator element 421b, metal layer 426 is moved in relation to coil 423b resulting in the disruption of an electrical field 428b (shown as dotted lines) generated by another device (not shown) imbedded in substrate 424b. In similar fashion to the operation of a metal detector, coil 423b receives an electric current reflecting the disruption caused by moving metal layer 426 in relation to electrical field 428b. This electric current represents a location of metal layer 426 relative to coil 423b.

Referring to FIG. 4c, a coil 423c associated with an inductive sensor is imbedded in a device substrate 424c. Again, device substrate 424c may be part of, for example, keyboard, a personal digital assistant, a cell phone, or other device as are known in the art. A thin, flexible actuator element 421c is anchored or otherwise disposed in relation to coil 423c. Thin, flexible actuator element 421c includes a metallic or other interfering material 427 imbedded within or over one or more surfaces of thin, flexible actuator element 421c. When a user's digit 422c applies force to thin, flexible actuator element 421c, metal layer 427 is moved in relation to coil 423c resulting in the disruption of an electrical field 428c (shown as dotted lines) generated by another device (not shown) imbedded in substrate 424c. In similar fashion to the operation of a metal detector, coil 423c receives an electric current reflecting the disruption caused by moving metal layer 427 in relation to electrical field 428c. This electric current represents a location of metal layer 427 relative to coil 423c.

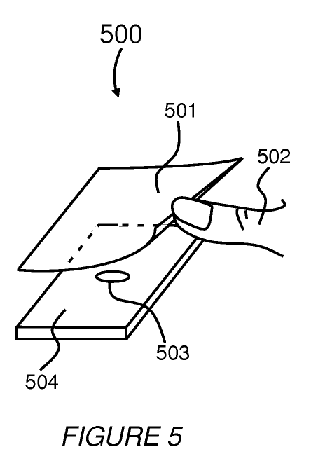

Turning to FIG. 5, an optical sensor 503 used to detect movement and/or location of a thin, flexible actuator element 501 is depicted in accordance with some embodiments of the present invention. Optical sensor 503 is imbedded or attached to a device substrate 504. Device substrate 504 may be part of, for example, keyboard, a personal digital assistant, a cell phone, or other device as are known in the art. Thin, flexible actuator element 501 is anchored or otherwise disposed in relation to optical sensor 503. When thin, flexible actuator element 501 is moved by, for example, application of force by a user's digit 502, an updated location of thin, flexible actuator element 501 is registered by optical sensor 503.

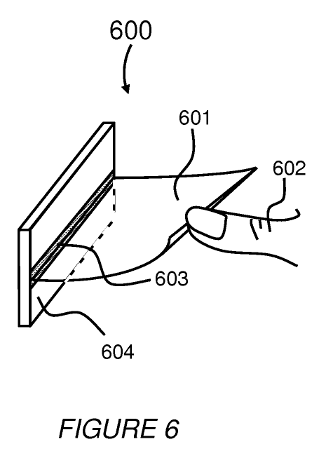

Turning to FIG. 6, a pressure sensor 603 is imbedded or attached to a device substrate 604. A thin, flexible actuator element 601 is attached to pressure sensor 603 such that when a user's digit 602 manipulates thin, flexible actuator element 601, resulting movement thereof is registered by pressure sensor 603. It should be noted that the aforementioned inductive, optical and pressure sensors are merely exemplary and that based on the disclosure provided herein, one of ordinary skill in the art will recognize a variety of other sensor types that may be used to detect the location and/or movement of a thin, flexible actuator element in accordance with different embodiments of the present invention.

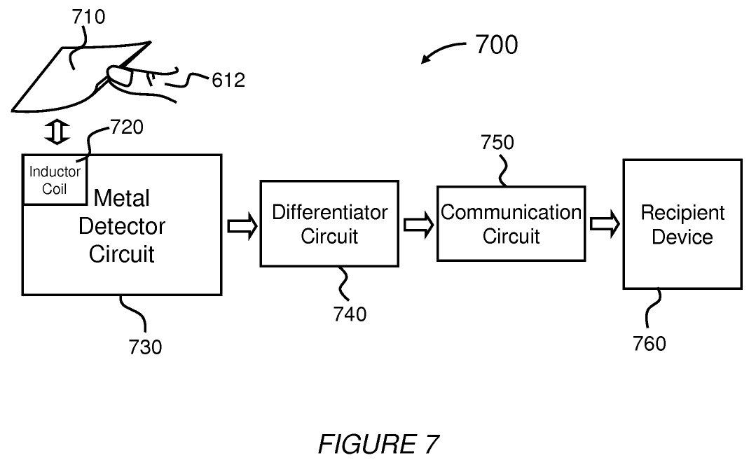

Turning to FIG. 7, a block diagram of a circuit 700 for detecting movement of a thin, flexible actuator element 710 using one or more inductive sensors in accordance with various embodiments of the present invention is depicted. Circuit 700 includes an inductive sensor including an inductor coil 720 and a circuit 730 similar to that implemented in a metal detector that is capable of detecting current changes in inductor coil 720 induced by movement of thin, flexible actuator element 710. As is known in the art, the current available from inductor coil 720 is proportional to a distance to an interfering metal layer disposed on or in thin, flexible actuator element 710. Metal detector circuit 730 provides a derivative of the sensed current to a differentiator circuit 740. In one particular embodiment of the present invention, differentiator circuit is an analog filter including an operational amplifier that both filters any noise from the sensed current, and provides a gain to the sensed current. The filtered current is converted to a digital representation by a communication circuit 750. The digital representation reflects the location of thin, flexible actuator element 710. Communication circuit 750 also transmits the digital information to a recipient device 760 that may be, for example, some type of personal electronics equipment. Recipient device 760 may then interpret the location information and use that information as discussed above.

In conclusion, the invention provides novel systems, devices, methods and arrangements for interacting with a computer. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A haptic interface device, the device comprising:
a thin, flexible passive actuating element, wherein the thin, flexible passive actuating element includes at least one unattached edge that is susceptible to manipulation; and
a sensor, wherein the sensor is operable to detect a manipulation of the thin, flexible passive actuating element and to provide an output corresponding to the detected manipulation.

2. The device of claim 1, wherein the thin, flexible passive actuating element provides a haptic feedback to a user providing the manipulation, and wherein the haptic feedback simulates the haptic sensation of paper.

3. The device of claim 1, wherein the sensor is coupled to the thin, flexible passive actuating element by a coupling mechanism selected from a group consisting of: a mechanical coupling, an electronic coupling, an acoustic coupling, an optical coupling, an RF coupling.

4. The device of claim 3, wherein the coupling mechanism is the electrical coupling, wherein the thin, flexible passive actuating element is a plastic sheet including a material capable of interfering with an electrical field, and wherein the sensor is an inductive sensor capable of producing an electrical field and of detecting an interference with the electrical field.

5. The device of claim 4, wherein the material capable of interfering with an electrical field is selected from a group consisting of: a metal disposed on a surface of the plastic sheet, and a metal embedded in the plastic sheet.

6. The device of claim 3, wherein the coupling is the mechanical coupling, and wherein the sensor is selected from a group consisting of: a force sensor, and a strain sensor.

7. The device of claim 1, wherein the output is an electrical signal, wherein the electrical signal corresponds to an electronic media navigation function, wherein the electronic media navigation function is selected from a group consisting of: a next page navigation, a previous page navigation, a bookmark navigation, a move to a bookmark navigation, a scroll navigation, and a highlighting navigation.

8. The device of claim 1, wherein the haptic interface device is associated with a processor and a computer readable medium, wherein the output is provided to the processor, and wherein the computer readable medium includes instructions executable by the processor to:
receive the output; and
generate a navigation command based at least in part on the output.

9. The device of claim 8, wherein the thin, flexible passive actuating element includes a first region and a second region, and wherein the computer readable medium further includes instructions executable to:
identify manipulation of the first section;
identify manipulation of the second section;
generate a first navigation command based at least in part on an identified manipulation of the first section;
generate a second navigation command based at least in part on an identified manipulation of the second section; and
wherein the first navigation command is distinct from the second navigation command.

10. The device of claim 8, wherein the navigation command is selected from a group consisting of: a next page navigation, a previous page navigation, a bookmark navigation, a move to a bookmark navigation, a scroll navigation, and a highlighting navigation.

11. The device of claim 1, wherein the manipulation is selected from a group consisting of: a movement of the thin, flexible passive actuating element; a force applied to the thin, flexible passive actuating element; a vibration of the thin, flexible passive actuating element; a location or position of the thin, flexible passive actuating element; and a sound emitted due to movement of thin, flexible passive actuating element.

12. The device of claim 1, wherein the sensor is selected from a group consisting of: a hall effect sensor, an optical sensor, an inductive sensor, a capacitive sensor, a thermal sensor, a stress or strain sensor, a force sensor, a radio frequency sensor, and a piezoelectric sensor.

13. The device of claim 1, wherein the device further comprises:
a base, wherein the sensor is incorporated into the base, and wherein the thin, flexible passive actuating element is attachable to the base and detachable from the base.

14. A method for navigating an electronic media displayed by an electronic device, the method comprising:
providing a haptic device, wherein the haptic device includes:
an actuating element, wherein the actuating element is a sheet of material that includes at least one unattached edge that is susceptible to manipulation;
a sensor;
a base, wherein the sensor is incorporated in the base, and wherein the actuating element is attached to the base;
detecting, by the sensor, a manipulation of the actuating element;
producing an electrical signal in response to the detected manipulation of the actuating element; and
navigating the electronic media based at least in part on the produced electrical signal.

15. The method of claim 14, wherein the actuating element includes a first region and a second region, wherein the electrical signal is a first electrical signal, wherein the manipulation of the actuating element is a manipulation of the first region, and wherein the method further comprises:
detecting, by the sensor, a manipulation of the second region; and
producing a second electrical signal in response to the detected manipulation of the second region.

16. An electronic device, wherein the electronic device comprises:
a haptic device, wherein the haptic device includes:
an actuating element, wherein the actuating element is a passive sheet of material that includes at least one unattached edge that is susceptible to manipulation;
a sensor, wherein the sensor is operable to detect a manipulation of the actuating element and to provide an output indicating the detected manipulation; and
a base, wherein the sensor is incorporated in the base, and wherein the actuating element is attached to the base;
a processor; and
a computer readable medium, wherein the computer readable medium includes instructions executable by the processor to:
receive the output; and
generate a navigation command based at least in part on the output.

17. The electronic device of claim 16, wherein the actuating element includes a first region and a second region, and wherein the computer readable medium further includes instructions executable to:
identify manipulation of the first section;
identify manipulation of the second section;
generate a first navigation command based at least in part on the identified manipulation of the first section;
generate a second navigation command based at least in part on the identified manipulation of the second section; and
wherein the first navigation command is distinct from the second navigation command.

18. The electronic device of claim 16, wherein the electronic device is a peripheral device selected from a group consisting of: a keyboard, a mouse, a display, a joystick, a touchpad, a gaming console, a television remote control, and an automobile steering wheel.

19. The electronic device of claim 16, wherein the electronic device includes a display.

20. The electronic device of claim 16, wherein the electronic device is selected from a group consisting of: a mobile telephone, an electronic reading device, a personal digital assistant, an audio player, a video player, a laptop computer, and a navigation device.
